(19) United States
(12) Patent Application Publication
(10) Pub. No.: US 2025/0319400 A1
(43) Pub. Date: Oct. 16, 2025

(54) Complex Part Pose Editing of Virtual Objects

(71) Applicant: Tencent Technology (Shenzhen) Company Limited, Shenzhen (CN)

(72) Inventors: Yingting Zhu, Shenzhen (CN); Liang Kang, Shenzhen (CN); Danxing Xu, Shenzhen (CN)

(21) Appl. No.: 19/250,601

(22) Filed: Jun. 26, 2025

Related U.S. Application Data
(63) Continuation of application No. PCT/CN2024/089036, filed on Apr. 22, 2024.

(30) Foreign Application Priority Data
Jun. 21, 2023 (CN) 2023107487205

(51) Int. Cl. A63F 13/55; A63F 13/533; A63F 13/63; G06N 3/08

(52) U.S. Cl. CPC A63F 13/55; A63F 13/533; A63F 13/63; G06N 3/08

(57) ABSTRACT

A pose editing method and apparatus for a complex body part of a virtual character are described herein, as applied to the field of three-dimensional virtual environments. Techniques may include displaying a model virtual character located in a virtual environment; displaying at least one candidate pose of a specified body part of the model virtual character, the candidate pose being configured for presenting the specified body part in a preset pose modeling; and switching, in response to a selection operation on a target pose of the at least one candidate pose, display of the specified body part of the model virtual character to a pose modeling corresponding to the target pose. The techniques described herein provide a simple pose editing scheme for a complex body part of a virtual character.

### CROSS-REFERENCE TO RELATED APPLICATIONS

This application is a Continuation application of PCT Application No. PCT/CN2024/089036, filed Jun. 22, 2024, which claims priority to Chinese Patent Application No. 2023107487205, filed Jun. 21, 2023, each entitled “POSE EDITING METHOD AND APPARATUS FOR COMPLEX PART, DEVICE, AND STORAGE MEDIUM” and each of which is incorporated herein by reference in its entirety.

### FIELD

Aspects described herein relate to the field of three-dimensional virtual environments, and in particular, to a pose editing method and apparatus for a complex part, a device, and a storage medium.

### BACKGROUND

In a game supporting a three-dimensional virtual environment, a user can control a virtual character in the three-dimensional virtual environment to perform various activities, such as walking, running, attacking, and releasing a skill.

In the related art, the virtual character is implemented by using a three-dimensional skeleton model. Poses of the virtual character in various activity states are presented according to a preset skeleton animation. For example, a process of a virtual character reaching out to release a skill may be presented through a preset skill animation.

However, a hand pose of the virtual character can only be a subset of the preset skeleton animation, and since the hand includes a plurality of fingers, involving dozens of bones, the user cannot customize the hand pose of the virtual character.

### SUMMARY

This application provides a pose editing method and apparatus for a complex part, a device, and a storage medium. Technical solutions provided in this application are as follows.

According to an aspect described herein, a pose editing method for a complex part is provided. The method is performed by a computer device and includes:
displaying a model virtual character located in a virtual environment;
displaying at least one candidate pose of a specified body part of the model virtual character, the candidate pose being configured for presenting the specified body part in a preset pose modeling; and
switching, in response to a selection operation on a target pose of the at least one candidate pose, display of the specified body part of the model virtual character to a pose modeling corresponding to the target pose.

According to another aspect described herein, a pose editing apparatus for a complex part is provided. The apparatus includes:
a display module, configured to display a model virtual character located in a virtual environment;
a selection module, configured to display at least one candidate pose of a specified body part of the model virtual character, the candidate pose being configured for presenting the specified body part in a preset pose modeling; and
an editing module, configured to switch, in response to a selection operation on a target pose of the at least one candidate pose, display of the specified body part of the model virtual character to a pose modeling corresponding to the target pose.

According to another aspect described herein, a computer device is provided. The computer device includes: a processor and a memory, the memory having a computer program stored therein, the computer program being loaded and executed by the processor, to implement the pose editing method for a complex part described above.

According to another aspect described herein, a computer-readable storage medium is provided. The computer-readable storage medium has a computer program stored therein, the computer program being loaded and executed by a processor to implement the pose editing method for a complex part described above.

According to another aspect described herein, a computer program product is provided. The computer program product has a computer program stored therein, the computer program being loaded and executed by a processor to implement the pose editing method for a complex part described above.

According to another aspect described herein, a chip is provided. The chip includes a programmable logic circuit and/or program instructions, a computer device installed with the chip being configured to implement the pose editing method for a complex part described above.

Beneficial effects brought by the technical solutions provided in the aspects described herein are at least as follows:

By providing at least one candidate pose of a specified body part for a player, and switching, in response to a selection operation on a target pose of the at least one candidate pose, display of the specified body part of a model virtual character to a pose modeling corresponding to the target pose, pose editing on a set of complex bones can be changed through a single editing operation, thereby providing a convenient pose editing scheme for the player. The user can conveniently generate various custom poses, so as to subsequently apply the generated custom poses to a virtual character controlled by the current user or another user.

### BRIEF DESCRIPTION OF THE DRAWINGS

FIG. 1 is a structural block diagram of a computer system according to an aspect described herein.

FIG. 2 is an interface diagram of a pose editing method for a complex part according to an aspect described herein.

FIG. 3 is a flowchart of a pose editing method for a complex part according to an aspect described herein.

FIG. 4 is a schematic diagram of a pose editing interface for a complex part according to an aspect described herein.

FIG. 5 is a flowchart of a method for activating a pose editing function according to an aspect described herein.

FIG. 6 is a schematic diagram of a first entry to a pose editing function according to an aspect described herein.

FIG. 7 is a schematic diagram of a second entry to a pose editing function according to an aspect described herein.

FIG. 8 is a schematic diagram of a working principle of a camera model in a virtual environment according to an aspect described herein.

FIG. 9 is a flowchart of a method for setting an initial pose according to an aspect described herein.

FIG. 10 is a schematic diagram of a skeleton model of a virtual character according to an aspect described herein.

FIG. 11 is a flowchart of a pose editing method for a complex part according to an aspect described herein.

FIG. 12 is a flowchart of a pose editing method for a complex part according to an aspect described herein.

FIG. 13 is a schematic diagram of a pose editing interface according to an aspect described herein.

FIG. 14 is a flowchart of a pose editing method for a complex part according to an aspect described herein.

FIG. 15 is a schematic diagram of a pose editing interface according to an aspect described herein.

FIG. 16 is a flowchart of a method for saving a custom pose according to an aspect described herein.

FIG. 17 is a flowchart of a method for applying a custom pose according to an aspect described herein.

FIG. 18 is a schematic diagram of an application interface for a custom pose according to an aspect described herein.

FIG. 19 is a schematic diagram of a sharing interface for a custom pose according to an aspect described herein.

FIG. 20 is a schematic diagram of a sharing interface for a custom pose according to an aspect described herein.

FIG. 21 is a flowchart of a pose editing method for a complex part according to an aspect described herein.

FIG. 22 is a schematic structural diagram of a pose editing apparatus for a complex part according to an aspect described herein.

FIG. 23 is a structural block diagram of a computer device according to an aspect described herein.

### DETAILED DESCRIPTION

To make objectives, technical solutions, and advantages described herein clearer, implementations described herein are described below in further detail with reference to the accompanying drawings. Illustrative aspects are described in detail herein, and examples of the illustrative aspects are shown in the accompanying drawings. When the following descriptions are made with reference to the accompanying drawings, unless otherwise indicated, the same numbers in different accompanying drawings represent the same or similar elements. Implementations described in the following illustrative aspects do not represent all implementations consistent with this application. On the contrary, the implementations are merely examples of an apparatus and a method which are consistent with some aspects described herein described in detail in the attached claims.

Terms used in this application are merely for an objective of describing specific aspects, but are not intended to limit this application. The singular forms “a”, “the”, and “this” used in this application and the appended claims are also intended to include plural forms, unless the context clearly indicates otherwise. The term “and/or” used herein includes any or all possible combinations of one or more associated listed items.

Although terms such as “first”, “second”, and “third”, may be used in this application to describe various information, the information is not to be limited by these terms. These terms are merely used for distinguishing between information of the same type.

First, related technologies in the aspects described herein are briefly described.

Virtual scene: It is a scene displayed or provided when a client of an application runs on a terminal device. The application includes, but is not limited to, a game application, an extended reality (XR) application, a social application, an interactive entertainment application, and the like. The virtual scene may be a simulated scene of a real world, or may be a semi-simulated and semi-fictional scene, or may be a purely fictional scene. The virtual scene may be a two-dimensional virtual scene, a 2.5-dimensional virtual scene, or a three-dimensional virtual scene. This is not limited in the aspects described herein.

Virtual character: It is a character that can move in the virtual scene. The virtual character may be in a character form, an animal form, a cartoon form, or another form. This is not limited in the aspects described herein. The virtual character may be presented in a three-dimensional form, or may be presented in a two-dimensional form. The aspects described herein are described by using the three-dimensional form as an example, but this is not limited thereto.

Bone chain: The virtual character in this application is implemented by using a skeleton model, and one skeleton model includes at least one bone chain. Each bone chain is formed by one or more rigid bones, with a joint connected between two adjacent bones. The joint may or might not have a movement capability. Some bones may rotate and move around the joints, and bone poses may be adjusted by adjusting joint parameters of the joints, thereby adjusting the skeleton pose, and finally implementing pose adjustment of the virtual character.

Modeling: It is a process of a user adjusting a virtual character to generate a personalized custom pose through a pose editor based on a preset initial pose of a system. Pose data and a pose preview of the custom pose may be saved as a modeling work, to facilitate applying or sharing the custom pose on virtual characters controlled by different accounts. The modeling work may be considered as a user generated content (UGC) work.

Modeling catalog: It is a network space or program function where a user uniformly stores modeling works generated by the user and modeling works collected from other users.

Share: It is to send a modeling work generated by a user to a network group, or share the modeling work to a friend account in a social relationship chain in a peer-to-peer manner. The social relationship chain may be a relationship chain in a game, or may be a relationship chain outside a game.

Collect: It is to save and collect modeling works generated and shared by others.

One-click apply: By using the one-click apply function, a modeling work created by a current user or another user may be quickly applied to a virtual character controlled by the current user.

Body shape: Body shapes of different virtual characters may be classified as follows: an adult male body shape, an adult female body shape, a teenage boy body shape, a teenage girl body shape, an elderly body shape, a child body shape, and the like. Due to space limitations, the aspects described herein are described by using the adult male body shape, the adult female body shape, and the teenage girl body shape as an example.

Heads-up display (HUD) control: It is a picture displaying related information or controls within a game, and is usually displayed on the top of a virtual environment picture. The virtual environment picture is a picture obtained by observing a three-dimensional virtual environment through a camera model. The HUD control is the most effective manner for a game world to interact with players, and elements that can convey information to the players through a visual effect can be referred to as HUD. Common HUD controls include an operation control, an inventory bar, a map, a health bar, and the like. The heads-up display control is also referred to as a head-up display control. In this application, all or some of editing controls are in the form of HUD controls.

Using the game application as an example, in a virtual scene of a fight technology game (FTG), an action game (ACT), a multiplayer online battle arena (MOBA) game, a real-time strategy (RTS) game, a massive/massively multiplayer online game (MMOG), a shooting game (STG), a first-person shooting (FPS) game, a third-person shooting (TPS) game, an arcade game, or the like, a pose/action of a virtual character controlled by a user is preset by the game, for example, a walking pose, a running pose, or a pose during skill release. The user cannot actively set the pose of the virtual character.

An aspect described herein provides a UGC function for a pose/action of a virtual character. This application supports a user in a game to customize and change bone positions of the virtual character based on preset basic poses of a system through a pose editor, to generate the personalized custom pose. In addition, the custom pose can be saved as a modeling work, and shared with other users for others to use and collect. Through a complete UGC production-sharing-application-collection system, common public users can obtain a UGC creation work from top users within the game more conveniently, create desires, share desires, and social needs of the top users are satisfied. It helps fill idle time and creates a good closed loop of social experience.

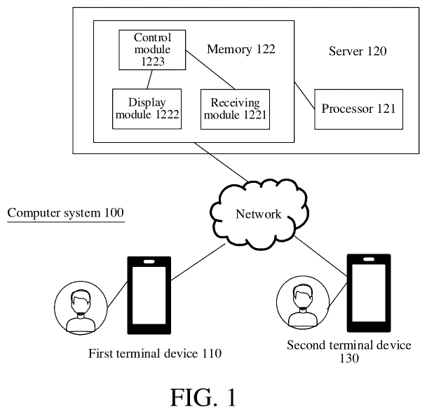

FIG. 1 is a structural block diagram of a computer system according to an illustrative aspect described herein. The computer system 100 includes at least one of a first terminal device 110, a server 120, or a second terminal device 130.

The first terminal device 110 is installed with and runs an application supporting a virtual environment, such as a game application, an XR application, a virtual social application, an interactive entertainment application, or a metaverse application. The first terminal device 110 is a terminal device used by a first user. A pose editor of a virtual character is set in the application, and is configured to generate, share, and collect the foregoing modeling work.

In some aspects, the first terminal device 110 may be considered as the first user using the first terminal device 110.

The first terminal device 110 is connected to the server 120 through a wireless network or wired network.

The server 120 includes one of one server, a plurality of servers, a cloud computing platform, and a virtualization center. For example, the server 120 includes a processor 121 and a memory 122, and the memory 122 further includes a receiving module 1221, a display module 1222, and a control module 1223. The server 120 is configured to provide a backend service for an application supporting the generation and/or display of a hit animation. In some aspects, the server 120 takes on primary computing work, and the first terminal device 110 and the second terminal device 130 take on secondary computing work; or the server 120 takes on secondary computing work, and the first terminal device 110 and the second terminal device 130 take on primary computing work; or a distributed computing architecture is used for collaborative computing between the server 120, the first terminal device 110, and the second terminal device 130

The second terminal device 130 is installed with and runs an application supporting a virtual environment. The second terminal device 130 is a terminal device used by a second user. A pose editor of a virtual character is set in the application.

In some aspects, the second terminal device 130 may be considered as the second user using the second terminal device 130.

In some aspects, the first user and the second user are or are not in the same field of view; or the first user and the second user are or are not in the same match; or the first user and the second user are or are not in the same battlefield. In some aspects, the first user and the second user may belong to the same team, the same organization, have a friend relationship, or have a temporary communication permission.

For example, the first user controls a first virtual character in the application by using a first account on the first terminal device, and the second user controls a second virtual character in the application by using a second account on the second terminal device.

In some aspects, the applications installed on the first terminal device 110 and the second terminal device 130 are the same, or the applications installed on the two terminal devices are the same type of applications on different control system platforms. The first terminal device 110 may generally refer to one of a plurality of terminal devices, and the second terminal device 130 may generally refer to one of a plurality of terminal devices. This aspect is described by only using the first terminal device 110 and the second terminal device 130 as an example. Device types of the first terminal device 110 and the second terminal device 130 are the same or different. The device types include, but are not limited to: at least one of a smartphone, a tablet computer, an e-book reader, a laptop portable computer, a desktop computer, a television, an augmented reality (AR) terminal device, a virtual reality (VR) terminal device, a mediated reality (MR) terminal device, an XR terminal device, a baffle reality (BR) terminal device, a cinematic reality (CR) terminal device, or a deceive reality (DR) terminal device. The following aspects are described by using an example in which the terminal device includes a smartphone.

A person skilled in the art may know that there may be more or fewer terminal devices or users. For example, there may be only one terminal device or user, or there may be dozens or hundreds of terminal devices or users, or more. The quantity of terminals or users and the device types are not limited in the aspects described herein.

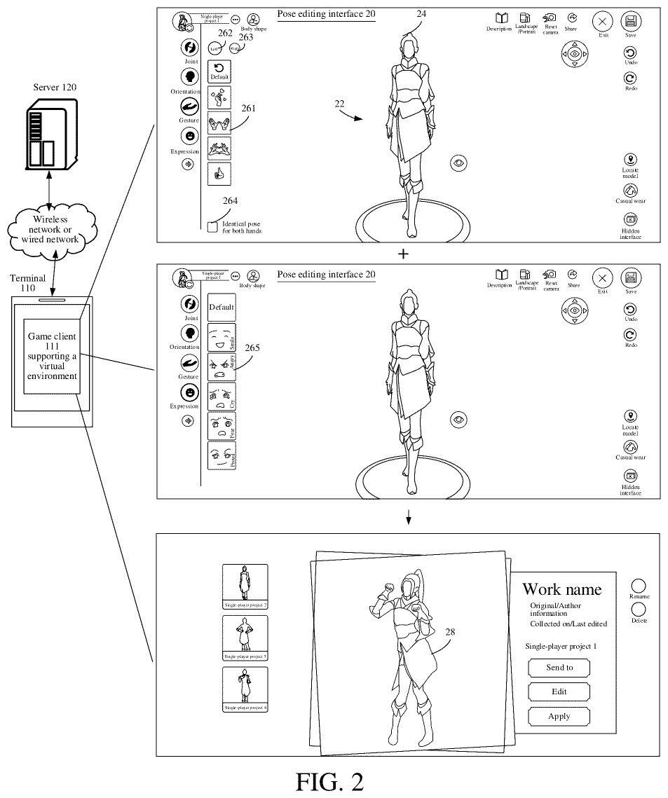

FIG. 2 is a schematic diagram of an interface for a pose editing method for a complex part according to an aspect described herein. A game client 111 supporting a virtual environment is run in the first terminal device 110. The game client 111 provides a pose editor for different body parts of a virtual character. After a user activates the pose editor, a pose editing interface 20 is displayed. The pose editing interface 20 displays a model virtual character 22. The model virtual character 22 is displayed based on a skeleton model. There are a plurality of editable candidate bone points 24 on the model virtual character 22, allowing for the editing of different joints and/or bones on the model virtual character 22.

This aspect described herein provides a convenient editing mode for a complex part. The complex part refers to a body part containing a plurality of bones. In this aspect, the complex part including a hand part and a face part is used as an example for description. The hand part may be referred to as a hand for short, and the face part may be referred to as a face for short.

In response to a trigger operation on a gesture menu, at least one candidate hand pose 261 of the hand part of the model virtual character 22 is displayed; and in response to a selection operation on a target hand pose of the at least one candidate hand pose 261, display of the hand part of the model virtual character is switched to a hand modeling corresponding to the target hand pose. In some aspects, the pose editing interface 20 further displays a first selection control 262, a second selection control 263, and a third selection control 264. When the first selection control 262 is checked, display of a left hand part of the model virtual character 22 is switched to the hand modeling corresponding to the target hand pose; when the second selection control 263 is checked, display of a right hand part of the model virtual character 22 is switched to the hand modeling corresponding to the target hand pose; and when the third selection control 264 is checked, display of the two hand parts of the model virtual character 22 is switched to the hand modeling corresponding to the target hand pose.

In response to a trigger operation on an expression menu, at least one candidate expression pose 265 of the face part of the model virtual character 22 is displayed; and in response to a selection operation on a target expression pose of the at least one candidate expression pose 265, display of the face part of the model virtual character 22 is switched to an expression modeling corresponding to the target expression pose.

The user may perform multiple pose edits on different body parts, to adjust a pose of the model virtual character 22 to a desired custom pose 28. Then, the user may save the custom pose 28 as a modeling work.

The custom pose 28 is a UGC work, which may be shared and applied among accounts of the game client. The custom pose 28 may be applied to a first virtual character controlled by the current user, or may be shared with another user to be applied to a second virtual character, a third virtual character, or the like controlled by the another user. Alternatively, after the custom pose 28 is saved by the current user, secondary editing may be performed to form another custom pose 28.

Information (including, but not limited to, user equipment information, user personal information, and the like), data (including, but not limited to, data for analysis, data for storage, data for presentation, and the like), and signals involved in this application are authorized by a user or are fully authorized by all parties, and collection, use, and processing of related data need to comply with related laws and regulations and standards of related countries and regions. For example, information involved in this application is obtained with sufficient authorization. The terminal device and the server buffer the information only during running of a program, and do not store and re-use related data of the information.

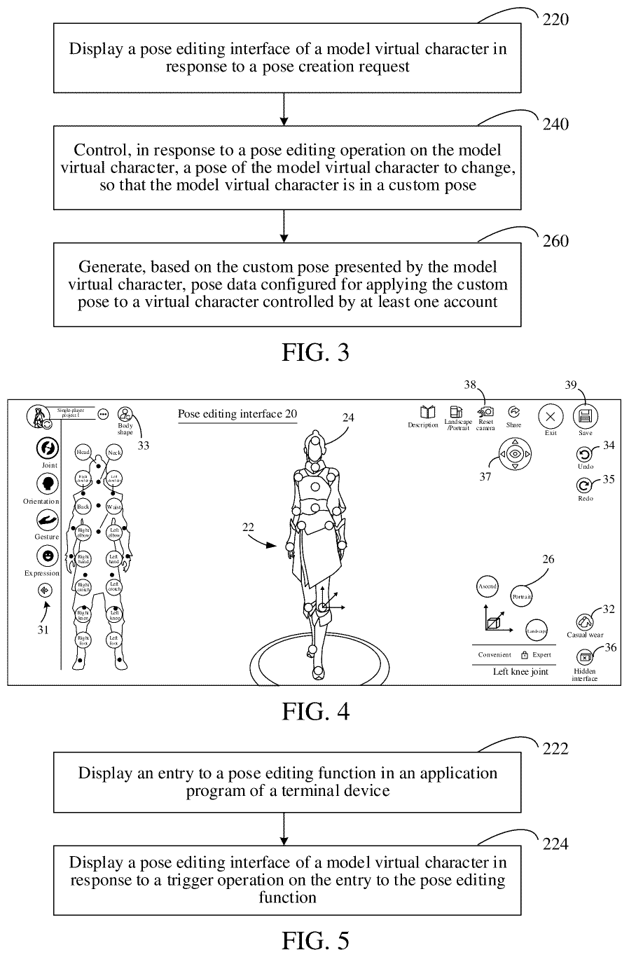

FIG. 3 is a schematic flowchart of a pose editing method for a complex part according to an illustrative aspect described herein. This aspect is described by using an example in which the method is performed by the first terminal device 110 and/or the second terminal device 130 shown in FIG. 1. The method includes at least some of the following operations.

Operation 220: Display a pose editing interface for a model virtual character in response to a pose creation request.

An application supporting a virtual environment is run on the terminal device, and the application may be a game client or a social client (for example, a metaverse social program). One or more virtual characters are provided in the application, each user account controls different virtual characters to complete a game match, and a friend relationship and/or a group relationship are formed between different user accounts.

For example, the game client includes a virtual character controlled by a user and a virtual character controlled by a non-user. The virtual character controlled by the user may be displayed in a display interface for the virtual character for the user to view. When the virtual character is displayed, a pose of the virtual character may be a preset pose of the game client. However, in this aspect described herein, the user may customize the pose of the virtual character.

If the user intends to customize the pose of the virtual character, the user performs a pose creation operation in the game client, to trigger the pose creation request. The terminal device displays the pose editing interface in response to the pose creation request. The pose editing interface is configured for editing the pose of the model virtual character. The pose editing interface includes the model virtual character located in the virtual environment, and the user performs pose editing on the model virtual character.

The model virtual character is a virtual character used as a model in a pose editing process. The model virtual character may be one of a plurality of candidate model virtual characters. The plurality of candidate model virtual characters may be classified according to factors such as a body shape, gender, and age. For example, the plurality of candidate model virtual characters include: a first model virtual character corresponding to an adult male body shape, a second model virtual character corresponding to an adult female body shape, a third model virtual character corresponding to a teenage girl body shape, and the virtual character controlled by the user (one of the foregoing three body shapes+a personalized face+personalized clothing).

Operation 240: Control, in response to a pose editing operation on the model virtual character, a pose of the model virtual character to change, so that the model virtual character is in a custom pose.

The user performs the pose editing operation on the model virtual character in the pose editing interface, and the terminal device controls, based on the pose editing operation performed by the user, the pose of the model virtual character to change according to instructions of the pose editing operation. A changed model virtual character is in the custom pose edited by the user, and the custom pose is a pose obtained after the pose of the model virtual character is changed based on at least one pose editing operation.

In different aspects, at least one of different body parts of the model virtual character is edited, to change the pose of the model virtual character. The different body parts include, but are not limited to, at least one of bone points (joints and/or bones), gestures, expressions, a face orientation, or an eye orientation.

For example, referring to FIG. 4, a plurality of menu options 31: a joint menu, an orientation menu, a gesture menu, and an expression menu, are displayed on the left side of the pose editing interface 20. The joint menu is configured for opening an editing control related to bone points. The orientation menu is configured for opening an editing control related to a face orientation and an eye orientation. The gesture menu is configured for opening an editing control related to gestures. The expression menu is configured for opening an editing control related to expressions.

Based on various editing controls shown in FIG. 4, pose editing on different body parts of the model virtual character may be implemented. The user may perform multiple pose edits on different bone points, to adjust the pose of the model virtual character to a desired custom pose.

Operation 260: Generate, based on the custom pose presented by the model virtual character, pose data configured for applying the custom pose to a virtual character controlled by at least one account.

When the pose of the model virtual character reaches a desired pose of the user, the user stops performing the pose editing operation, and performs a pose generation operation on the model virtual character, to trigger a pose generation request. In response to the pose generation request, the terminal device generates the pose data of the custom pose based on the model virtual character in the custom pose. The pose data is configured for indicating the custom pose.

In conclusion, according to the method provided in this aspect described herein, a user can flexibly generate various poses by performing a pose editing operation on a model virtual character, and subsequently apply a generated custom pose to a virtual character controlled by the current user or another user, to implement a UGC generation, application, and sharing scheme for a pose of the virtual character.

### 1. Entry to Pose Editing Function

FIG. 5 is a flowchart of a method for enabling a pose editing function according to an illustrative aspect described herein. This aspect is described by using an example in which the method is performed by a terminal device. The method includes the following operations.

Operation 222: Display an entry to a pose editing function in an application of a terminal device.

Assuming that the application is logged in with a first account, a user controls, in the application, a first virtual character corresponding to the first account to perform various activities. The application provides a plurality of functions, including, but are not limited to, a combat function, task execution, transaction, and the like. In this aspect, the application provides the entry to the pose editing function.

There are one or more entries to the pose editing function. For example, the entry to the pose editing function includes, but is not limited to, at least one of the following:
a first entry to the pose editing function for new creation and editing based on a preset pose of a system; and
a second entry to the pose editing function for secondary editing based on the created pose.

Operation 224: Display a pose editing interface for a model virtual character in response to a trigger operation on the entry to the pose editing function.

The trigger operation is at least one of a click operation, a double click operation, a press operation, a slide operation, a voice control operation, or an eye control operation.

The pose editing interface for the model virtual character is displayed in response to the trigger operation on the entry to the pose editing function. The pose editing interface includes: a model virtual character located in a virtual environment, and at least one editing control configured for pose editing.

In some aspects, the virtual environment is an independent virtual environment dedicated to pose editing. The virtual environment is different from a virtual world in which the virtual character engages in daily activities. In some aspects, the virtual environment may alternatively be a part of the virtual world in which the virtual character engages in daily activities, for example, a yard or a house.

In some aspects, in a case that the entry is the first entry, an initial pose of the model virtual character is a default pose, for example, a standing pose with both hands hanging down. In a case that the entry is the second entry, the initial pose of the model virtual character is a created pose.

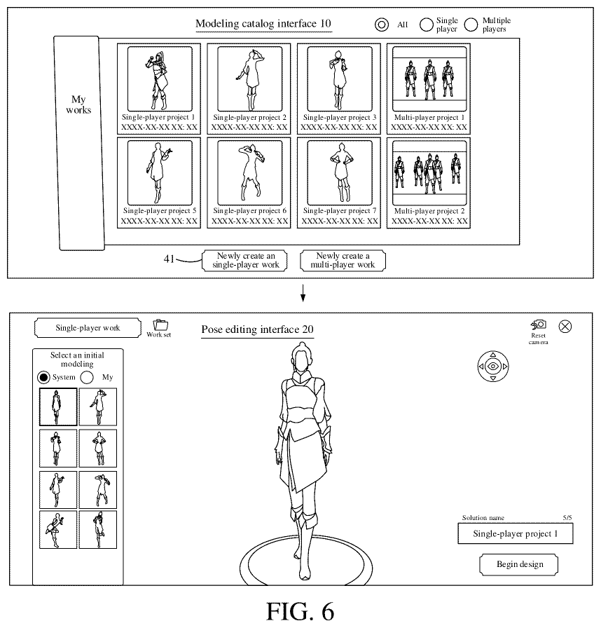

For example, referring to FIG. 6, a modeling catalog interface 10 of the application displays an option for creating a new single-player work, which is the first entry to the pose editing function for new creation and editing based on the preset pose of the system. In response to a trigger operation on the option 41 for creating a new single-player work, the pose editing interface 20 of the model virtual character is displayed. In the pose editing interface 20, the initial pose of the model virtual character is the default pose.

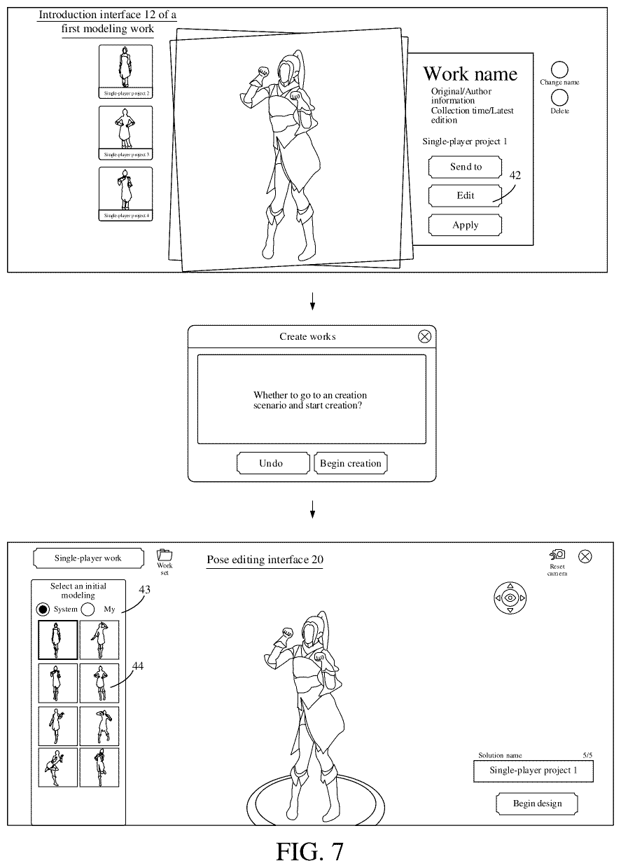

For example, referring to FIG. 7, the modeling catalog interface for the application displays the created modeling work. In response to a selection operation on a first modeling work, an introduction interface 12 of the first modeling work is displayed. The first modeling work is a modeling work created by the first account or another account. The introduction interface 12 of the first modeling work displays an editing button 42. The editing button 42 is the second entry to the pose editing function for secondary editing based on the created pose. In response to a trigger operation on the editing button 42, the pose editing interface 20 of the model virtual character is displayed. In the pose editing interface 20, the pose of the model virtual character is a pose corresponding to the first modeling work. In some aspects, secondary editing requires user confirmation before proceeding, to avoid misoperation by the user.

For example, with reference to FIG. 4, the pose editing interface 20 further displays several general function buttons. For example:

### Casual Wear Button 32

The model virtual character 22 in the pose editing interface 20 is displayed based on a skeleton model and clothing attached to the outside of the skeleton model. By default, the clothing attached to the outside of the skeleton model is long clothing.

In response to a selection operation on the casual wear button 32, the long clothing on the model virtual character 22 is replaced with underwear to expose body parts of the model virtual character 22, to help the user to view bone changes on the skeleton model of the model virtual character 22 in the pose editing process. In response to a deselection operation on the casual wear button 32, the underwear on the model virtual character 22 is replaced with the long clothing, to help the user to view an overall modeling change of the model virtual character 22 in the pose editing process.

### Body Shape Switch Button 33

The pose editing interface 20 further provides a plurality of candidate model virtual characters, and body shapes corresponding to the candidate model virtual characters may be different. This aspect is described by using an example in which three body shapes are provided. The plurality of candidate model virtual characters include: a first model virtual character corresponding to an adult male body shape, a second model virtual character corresponding to an adult female body shape, a third model virtual character corresponding to a teenage girl body shape, and the virtual character controlled by the user (one of the foregoing three body shapes+a personalized face+personalized clothing).

In some aspects, in response to a trigger operation on the body shape switch button 33, the model virtual character 22 in the pose editing interface 20 is switched to a model virtual character of another body shape.

In some aspects, in response to the trigger operation on the body shape switch button 33, the plurality of candidate model virtual characters are displayed; and in response to a selection operation on one of the plurality of candidate model virtual characters, the model virtual character 22 in the pose editing interface 20 is switched to the selected model virtual character.

### Undo Button 34 and Redo Button 35

In response to a trigger operation on the undo button 34, the most recent pose editing operation is undone; and in response to a trigger operation on the redo button 35, the most recently undone pose editing operation is redoned.

### Hide Button 36

In response to a trigger operation on the hide button 36, all or some of a plurality of editing controls are hidden, to facilitate providing more display space for the model virtual character 22 in the pose editing interface 20.

### Camera Control Widget 37

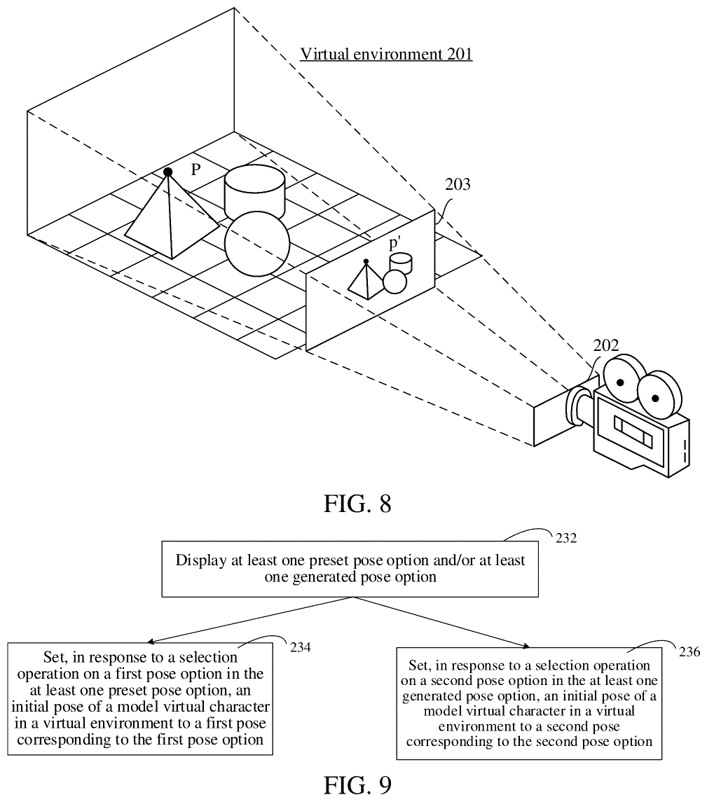

A picture of the model virtual character 22 located in the virtual environment is captured by a virtual camera model (camera for short). FIG. 8 is a schematic diagram of a working principle of a camera model located in a virtual environment according to an aspect described herein. The schematic diagram shows a process of mapping a feature point p in the virtual environment 201 to a feature point p′ in an imaging plane 203. Coordinates of the feature point p in the virtual environment 201 are in a three-dimensional form, and coordinates of the feature point p′ in the imaging plane 203 are in a two-dimensional form. The virtual environment 201 is a virtual environment corresponding to a three-dimensional virtual environment. A camera plane 202 is determined by a pose of the camera model, the camera plane 202 is a plane perpendicular to a photographing direction of the camera model, and the imaging plane 203 and the camera plane 202 are parallel to each other. The imaging plane 203 is a plane in which the virtual environment within the field of view is imaged by the camera model when the virtual environment is observed.

The camera control widget 37 is configured to control a position of the camera in the virtual environment. Using an example in which the camera control widget 37 is a joystick, in response to a drag operation performed on the joystick 37 in at least one of directions of up, down, left, and right, the camera is controlled to move in the virtual environment in a corresponding direction.

In some aspects, in response to an upward slide operation in the blank of the pose editing interface 20, the camera is controlled to rotate upward in the virtual environment; in response to a downward slide operation in the blank of the pose editing interface 20, the camera is controlled to rotate downward in the virtual environment; in response to a leftward slide operation in the blank of the pose editing interface 20, the camera is controlled to rotate leftward in the virtual environment; and in response to a rightward slide operation in the blank of the pose editing interface 20, the camera is controlled to rotate rightward in the virtual environment.

In some aspects, in response to a pinch-to-zoom operation or a mouse scroll zoom operation in the blank of the pose editing interface 20, the camera is controlled to move forward or backward in the virtual environment, to zoom in or out to adjust a size of the model virtual character in the virtual environment.

In some aspects, the camera control widget 37 is displayed in a form of a floating joystick. Some of the editing controls in the pose editing interface are displayed by using a floating window. When the floating window is dragged to a position of the camera control widget 37, the camera control widget adaptively offsets to another idle position in the pose editing interface 20.

### Reset Camera Button 38

Since the user may change the position of the camera for multiple times, in response to a trigger operation on the reset camera button, the position of the camera is quickly returned to a default initial position. For example, the default initial position of the camera is a center position directly in front of the model virtual character.

In some aspects, a single-player mode and a multi-player mode each require one default camera configuration, and configuration parameters in the two default camera configurations are different.

### 2. Manner of Determining Initial Pose

FIG. 9 is a flowchart of a method for setting an initial pose according to an illustrative aspect described herein. This aspect is described by using an example in which the method is performed by a terminal device. The method includes the following operations.

Operation 232: Display at least one preset pose option and/or at least one generated pose option.

The preset pose option is a pose option natively provided by the application, and the generated pose option is a pose option corresponding to the custom pose edited by the first account and/or another account.

In some aspects, the at least one generated pose option is a pose option corresponding to a modeling work collected by the first account.

For example, as shown in FIG. 7, the pose editing interface 20 displays an initial pose selection control 43. The initial gesture selection control 43 has two menu bars: A first menu bar “System” is configured for triggering to display at least one preset pose option 44 in the initial pose selection control 43, and a second menu bar “My” is configured for triggering to display at least one generated pose option of the initial pose selection control 43.

In some aspects, the initial pose selection control 43 in a display state by default when entering the pose editing interface. The display of the initial pose selection control 43 is cancelled after the user selects an initial pose option. In a subsequent editing process, in response to a display operation on the initial pose selection control 43, the initial pose selection control 43 is switched from a hidden state to the display state. In response to a hide operation on the initial pose selection control 43, the initial pose selection control 43 is switched from the display state to the hidden state.

For example, as shown in FIG. 7, the at least one preset pose option includes: a gentle blowing pose, a wishing pose, a fist-raising pose, a hands-on-hips pose, an arms-crossed pose, and the like.

Operation 234: Set, in response to a selection operation on a first pose option of the at least one preset pose option, an initial pose of the model virtual character in the virtual environment to a first pose corresponding to the first pose option.

In some aspects, the first pose option correspondingly stores pose data corresponding to the first pose. The pose data corresponding to the first pose is imported into the skeleton model of the model virtual character, to set the initial pose of the model virtual character in the virtual environment to the first pose corresponding to the first pose option.

Operation 236: Set, in response to a selection operation on a second pose option of the at least one generated pose option, an initial pose of the model virtual character in the virtual environment to a second pose corresponding to the second pose option.

In some aspects, the second pose option correspondingly stores pose data corresponding to the second pose. The pose data corresponding to the second pose is imported into the skeleton model of the model virtual character, to set the initial pose of the model virtual character in the virtual environment to the second pose corresponding to the second pose option.

In some aspects, in the pose editing process, the user may still change the initial pose of the model virtual character. In a process of switching to a next initial pose, if the initial pose before switching has been edited, a secondary confirmation is required before switching to the next initial pose.

In conclusion, according to the method provided in this aspect, by providing at least one preset pose option preset by a system, a user can use several relatively based preset poses as a creation starting point for a custom pose, thereby reducing a large quantity of operations in a pose editing process. For an electronic device with limited operation manners, such as a mobile phone or a tablet computer, costs of human-computer interactions of the user can be reduced, making it easier to create a more personalized custom pose with fewer human-computer interactions.

According to the method provided in this aspect, further, by providing at least one generated pose option created by the current user and/or another user, the current user can use the custom pose generated by another user as a starting point for secondary creation, and can add creativity on creative ideas of another user, thereby facilitating generation of a custom pose that merges creative ideas of different users.

### 3. Pose Editing Function

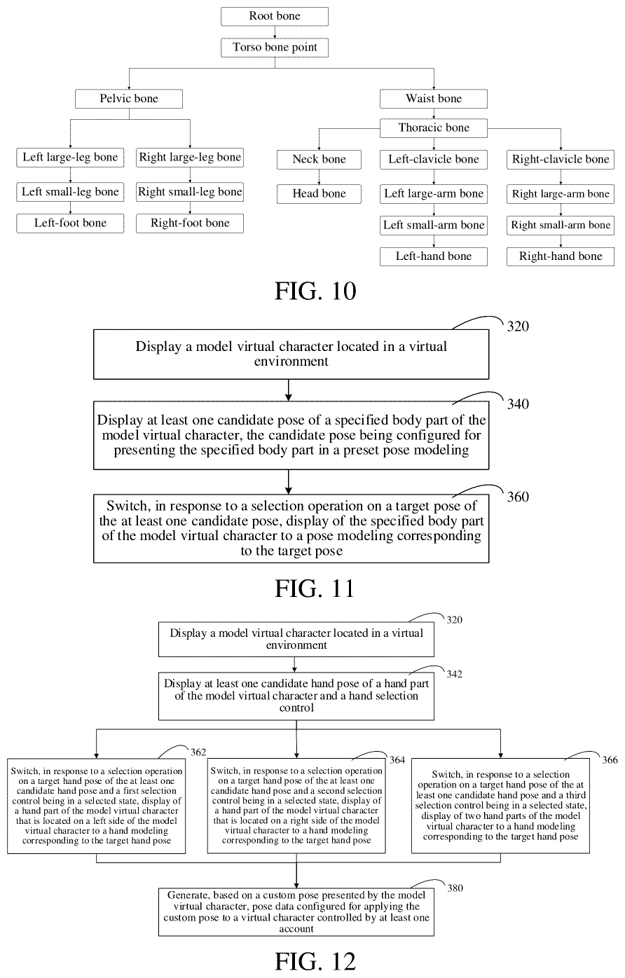

FIG. 10 is a schematic diagram of a skeleton model of a virtual character according to an illustrative aspect described herein. The skeleton model includes a plurality of bone chains. Each bone chain includes at least one bone, with joints formed between adjacent bones.

For example, the plurality of bone chains include:
A head bone chain, including: a head bone and a neck bone. To display different expressions, the head bone includes a plurality of face bones, such as a left eyebrow bone, a left eye bone, a left ear bone, a left cheekbone, a right eyebrow bone, a right eye bone, a right ear bone, a right cheekbone, a nose bone, an upper lip bone, and a lower lip bone.
An upper body bone chain, including: a chest bone, a waist bone, a left arm bone chain, and a right arm bone chain. The left arm bone chain includes: a left clavicle bone, a left upper arm bone, a left lower arm bone, and a left hand bone. The right arm bone chain includes: a right clavicle bone, a right upper arm bone, a right lower arm bone, and a right hand bone. To display different gestures, the right hand bone includes a plurality of finger bones and a plurality of palm bones. Similarly, the left hand bone includes a plurality of finger bones and a plurality of palm bones.
A lower body bone chain, including: a pelvic bone, a left leg bone chain, and a right leg bone chain. The left leg bone chain includes: a left thigh bone, a left chin bone, and a left foot bone; and the right leg bone chain includes: a right thigh bone, a right chin bone, and a right foot bone.

Representative joints or bones in the skeleton model are set as editable bone points. For example, the editable bone points include: a head bone point, a neck bone point, a chest bone point, a waist bone point, a left shoulder bone point, a left elbow bone point, a left hand bone point, a right shoulder bone point, a right elbow bone point, a right hand bone point, a left crotch bone point, a left knee bone point, a left foot bone point, a right crotch bone point, a right knee bone point, and a right foot bone point.

For example, the pose editing interface displays at least one of the following mode selection buttons: a joint mode, an orientation mode, a gesture mode, and an expression mode.

This application focuses on the related parts about the gesture mode and the expression mode.

FIG. 11 is a flowchart of a pose editing method for a complex part according to an illustrative aspect described herein. This aspect is described by using an example in which the method is performed by a terminal device. The method includes the following operations.

Operation 320: Display a model virtual character located in a virtual environment.

The model virtual character located in the virtual environment is displayed in a pose editing interface. The model virtual character is displayed based on a skeleton model. The model virtual character includes a plurality of body parts.

For example, the model virtual character includes: at least one body part of a head part, a torso part, an extremity part, a hand part, a face part, or a foot part.

In the foregoing body parts, some body parts include a larger quantity of bones, making it cumbersome for the user to adjust each bone individually. For example, the face part usually has 36 bones, making it quite difficult for the user to adjust each bone individually to achieve a desired expression pose.

In this aspect, a specified body part is a body part with a quantity of bones exceeding a preset threshold. The preset threshold may be 3, 5, or the like. The specified body part may alternatively be specified in advance by a developer according to expert experience.

Operation 340: Display at least one candidate pose of a specified body part of the model virtual character, the candidate pose being configured for presenting the specified body part in a preset pose modeling.

The pose editing interface displays one or more candidate poses of the specified body part of the model virtual character. Each candidate pose is configured for presenting the specified body part in the preset pose modeling. Pose modelings of different candidate poses are different.

Operation 360: Switch, in response to a selection operation on a target pose of the at least one candidate pose, display of the specified body part of the model virtual character to a pose modeling corresponding to the target pose.

For example, in response to the selection operation on the target pose of a plurality of candidate poses, display of the specified body part of the model virtual character is switched to the pose modeling corresponding to the target pose.

In some aspects, the specified body part includes: a hand part. At least one candidate hand pose of the hand part of the model virtual character is displayed. In response to a selection operation on a target hand pose of the at least one candidate hand pose, display of the hand part of the model virtual character is switched to a hand modeling corresponding to the target hand pose.

In some aspects, the specified body part includes: a face part. At least one candidate expression pose of the face part of the model virtual character is displayed. In response to a selection operation on a target expression pose of the at least one candidate expression pose, display of the face part of the model virtual character is switched to an expression modeling corresponding to the target expression pose.

In conclusion, according to the method provided in this aspect, by providing at least one candidate pose of a specified body part for a player, and switching, in response to a selection operation on a target pose of the at least one candidate pose display of the specified body part of a model virtual character to a pose modeling corresponding to the target pose, pose editing on a set of complex bones can be changed through a single editing operation, thereby providing a convenient pose editing scheme for the player. The user can conveniently generate various custom poses, so as to subsequently apply the generated custom poses to a virtual character controlled by the current user or another user, thereby achieving a UGC generation, application, and sharing scheme for the virtual character pose.

### For a Gesture Mode:

FIG. 12 is a flowchart of a pose editing method for a complex part according to an illustrative aspect described herein. This aspect is described by using an example in which the method is performed by a terminal device. The method includes the following operations.

Operation 320: Display a model virtual character located in a virtual environment.

The model virtual character located in the virtual environment is displayed in a pose editing interface. The model virtual character is displayed based on a skeleton model. The model virtual character includes a hand part.

Operation 342: Display at least one candidate hand pose of the hand part of the model virtual character and a hand selection control, the candidate hand pose being configured for presenting the hand part in a preset hand modeling.

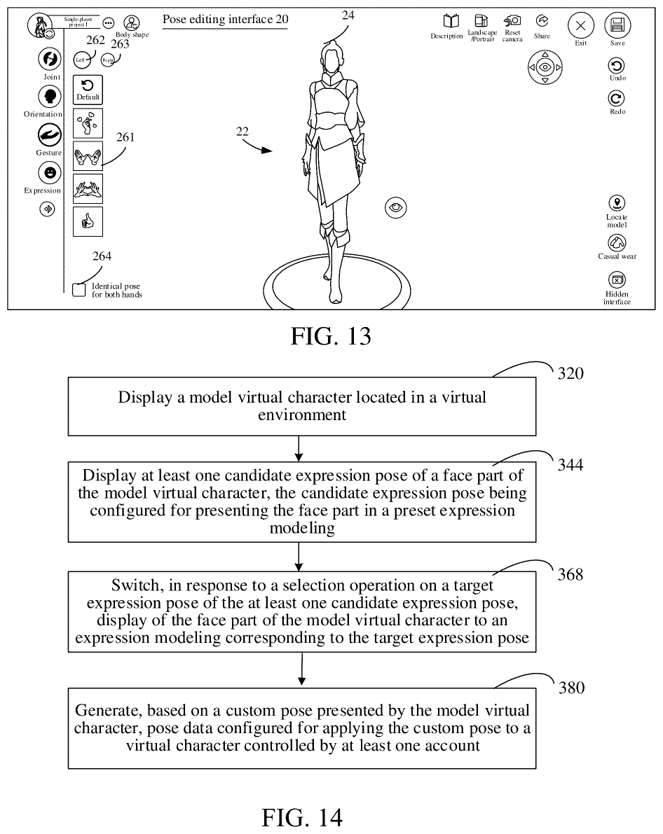

For example, referring to FIG. 13, a pose editing interface 20 displays one or more candidate hand poses 261 of a hand part of a model virtual character 22. Each candidate hand pose 261 is configured for presenting the hand part in the preset hand modeling. Pose modelings of different candidate hand poses are different.

In some aspects, the candidate hand pose 261 includes: at least one of a V-sign victory gesture, a straightened closed gesture, a relaxed resting gesture, a thumbs-up gesture, a heart gesture, a relaxed flower hand gesture, an open palm gesture, a first gesture, or an open hand gesture.

In some aspects, the hand selection control includes at least one of a first selection control, a second selection control, or a third selection control, and the first selection control, the second selection control, and the third selection control are different controls. For example, the first selection control may also be referred to as a left-hand selection control, configured to select a left hand part. For example, the second selection control may also be referred to as a right-hand selection control, configured to select a right hand part. For example, the third selection control may also be referred to as a two-hand selection control, configured to select the left hand part and the right hand part at the same time.

In some aspects, as shown in FIG. 13, the hand selection control includes a left-hand selection control 262, a right-hand selection control 263, and a two-hand selection control 264. The left-hand selection control 262 is configured to select the left hand part; the right-hand selection control 263 is configured to select the right hand part; and the two-hand selection control 264 is configured to select the left hand part and the right hand part at the same time.

Operation 362: Switch, in response to a selection operation on a target hand pose of the at least one candidate hand pose and a first selection control being in a selected state, display of a hand part of the model virtual character that is located on a left side of the model virtual character to a hand modeling corresponding to the target hand pose.

In some aspects, local bone data corresponding to the left hand part is prestored for each candidate hand pose 261. If there are model virtual characters of a plurality of body shapes, the local bone data corresponding to the left hand part of the candidate hand pose 261 is further stored for the model virtual character of each body shape.

In response to the selection operation on the target hand pose of the at least one candidate hand pose and the first selection control being in the selected state, local bone data of the target hand pose is queried based on the body shape of the model virtual character, an identification (ID) of the target hand pose, and a left hand identifier. The local bone data of the hand part of the model virtual character that is located on the left side of the model virtual character is replaced with the local bone data of the target hand pose.

Operation 364: Switch, in response to a selection operation on a target hand pose of the at least one candidate hand pose and a second selection control being in a selected state, display of a hand part of the model virtual character that is located on a right side of the model virtual character to a hand modeling corresponding to the target hand pose.

In some aspects, local bone data corresponding to the right hand part is prestored for each candidate hand pose 261. If there are model virtual characters of a plurality of body shapes, the local bone data corresponding to the right hand part of the candidate hand pose 261 is further stored for the model virtual character of each body shape.

In response to the selection operation on the target hand pose of the at least one candidate hand pose and the second selection control being in the selected state, local bone data of the target hand pose is queried based on the body shape of the model virtual character, an ID of the target hand pose, and a right hand identifier. The local bone data of the hand part of the model virtual character that is located on the right side of the model virtual character is replaced with the local bone data of the target hand pose.

Operation 366: Switch, in response to a selection operation on a target hand pose of the at least one candidate hand pose and a third selection control being in a selected state, display of two hand parts of the model virtual character to a hand modeling corresponding to the target hand pose.

For the same target hand pose, the target hand pose of the left hand part and the target hand pose of the right hand part are symmetrical.

Operation 380: Generate, based on a custom pose presented by the model virtual character, pose data configured for applying the custom pose to a virtual character controlled by at least one account.

When the pose of the model virtual character reaches a desired pose of the user, the user stops performing the pose editing operation, and performs a pose generation operation on the model virtual character, to trigger a pose generation request. The terminal device generates the pose data of the custom pose based on the model virtual character in the custom pose in response to the pose generation request. The pose data may be absolute pose data or relative pose data. The absolute pose data is bone data of the custom pose in the virtual environment. The relative pose data is configured for indicating a bone offset value of the custom pose relative to an initial pose.

The pose data and attached information of the custom pose are saved as a modeling work of the custom pose. The attached information includes: at least one of the following: account information of a creator, creation time, personalized information of the model virtual character, body shape information of the model virtual character, pose data of the initial pose of the model virtual character, a name of the custom pose, or a preview of the custom pose.

The modeling work of the custom pose may be applied to a virtual character controlled by the first account, or may be shared by the first account with another account and then applied to a virtual character controlled by the another account. Therefore, the custom pose is used as a type of UGC content to be shared and applied between accounts.

In conclusion, according to the method provided in this aspect, by providing at least one candidate hand pose of a hand part for a player, and switching, in response to a selection operation on a target hand pose of the at least one candidate hand pose, display of the hand part of a model virtual character to a hand pose modeling corresponding to the target hand pose, hand pose editing on the entire hand part can be changed through a single editing operation, thereby providing a convenient hand pose editing scheme for the player. The user can conveniently generate various customized hand poses, so as to subsequently apply the generated customized hand poses to a virtual character controlled by the current user or another user, thereby achieving a UGC generation, application, and sharing scheme for the virtual character hand pose.

In addition, this application provides a first selection control, a second selection control, and a third selection control, which are respectively configured to switch display of a left hand, a right hand, or both hands of a model virtual character to the hand modeling corresponding to the target hand pose, to satisfy different requirements of the user for editing the left hand alone, editing the right hand alone, and editing the both hands simultaneously, thereby achieving editing flexibility.

### For an Expression Mode:

FIG. 14 is a flowchart of a pose editing method for a complex part according to an illustrative aspect described herein. This aspect is described by using an example in which the method is performed by a terminal device. The method includes the following operations.

Operation 320: Display a model virtual character located in a virtual environment.

The model virtual character located in the virtual environment is displayed in a pose editing interface. The model virtual character is displayed based on a skeleton model. The model virtual character includes a plurality of body parts.

For example, the model virtual character includes: at least one body part of a head part, a torso part, an extremity part, a hand part, a face part, or a foot part.

In the foregoing body parts, some body parts include a larger quantity of bones, making it cumbersome for the user to adjust each bone individually. For example, the face part usually has 36 bones, making it quite difficult for the user to adjust each bone individually to achieve a desired expression pose.

In this aspect, a specified body part is a body part with a quantity of bones exceeding a preset threshold. The preset threshold may be 3, 5, or the like. The specified body part may alternatively be specified in advance by a developer according to expert experience.

Operation 344: Display at least one candidate expression pose of a face part of the model virtual character, the candidate expression pose being configured for presenting the face part in a preset expression modeling.

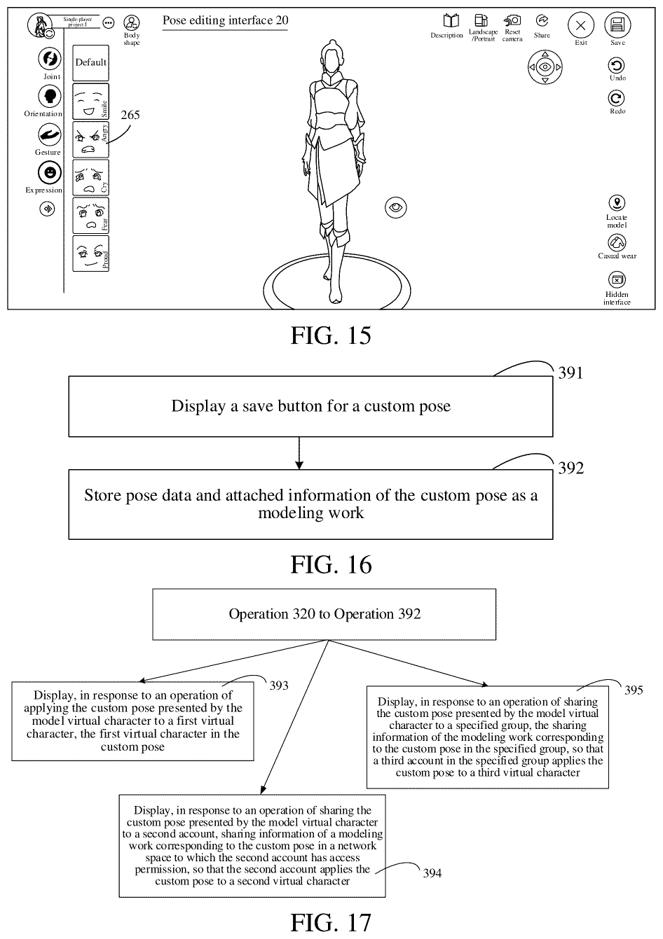

For example, referring to FIG. 15, a pose editing interface 20 displays one or more candidate expression poses of the face part of a model virtual character 22. Each candidate expression pose is configured for presenting the face part in the preset expression pose modeling. Pose modelings of different candidate expression poses are different.

In some aspects, the candidate expression pose includes at least one of a smiling expression, a cool expression, a squinting expression, a staring expression, an eyes closed expression, a single-eye closed expression, an angry expression, or a joyful laugh expression.

Operation 368: Switch, in response to a selection operation on a target expression pose of the at least one candidate expression pose, display of the face part of the model virtual character to an expression modeling corresponding to the target expression pose.

In some aspects, if there are model virtual characters of a plurality of body shapes, local bone data corresponding to the target expression pose is further stored for the model virtual character of each body shape.

In response to the selection operation on the target expression pose of the at least one candidate expression pose, the local bone data of the target expression pose is queried based on a body shape of the model virtual character and an ID of the target expression pose. Local bone data of the face part of the model virtual character is replaced with the local bone data of the target expression pose. In this way, in the interface, display of the face part of the model virtual character is switched to the expression modeling corresponding to the target expression pose.

Operation 380: Generate, based on a custom pose presented by the model virtual character, pose data configured for applying the custom pose to a virtual character controlled by at least one account.

When the pose of the model virtual character reaches a desired pose of the user, the user stops performing the pose editing operation, and performs a pose generation operation on the model virtual character, to trigger a pose generation request. The terminal device generates the pose data of the custom pose based on the model virtual character in the custom pose in response to the pose generation request. The pose data may be absolute pose data or relative pose data. The absolute pose data is bone data of the custom pose in the virtual environment. The relative pose data is configured for indicating a bone offset value of the custom pose relative to an initial pose.

The pose data and attached information of the custom pose are saved as a modeling work of the custom pose. The attached information includes: at least one of account information of a creator, creation time, personalized information of the model virtual character, body shape information of the model virtual character, pose data of the initial pose of the model virtual character, a name of the custom pose, or a preview of the custom pose.

The modeling work of the custom pose may be applied to a virtual character controlled by the first account, or may be shared by the first account with another account and then applied to a virtual character controlled by the another account. Therefore, the custom pose is used as a type of UGC content to be shared and applied between accounts.

In conclusion, according to the method provided in this aspect, by providing at least one candidate expression pose of a face part for a player, and switching, in response to a selection operation on a target expression pose of the at least one candidate expression pose, display of the face part of a model virtual character to an expression pose modeling corresponding to the target expression pose, expression pose editing on the entire face part can be changed through a single editing operation, thereby providing a convenient expression pose editing scheme for the player. The user can conveniently generate various customized expression poses, so as to subsequently apply the generated customized expression poses to a virtual character controlled by the current user or another user, thereby achieving a UGC generation, application, and sharing scheme for the expression pose of the virtual character.

In addition, pose data for applying a custom pose to a virtual character controlled by at least one account is generated based on the custom pose presented by the model virtual character, so that the custom pose of the model virtual character is applied to the virtual character controlled by the at least one account. A gesture pose of the model virtual character may be applied to a gesture of the virtual character controlled by the at least one account, and an expression pose of the model virtual character may also be applied to an expression of the virtual character controlled by the at least one account, reflecting flexibility of applying the custom pose.

Due to the limited quantity of candidate poses of the same body part, a personalized requirement of the user might not be completely satisfied. An aspect described herein further provides a candidate pose generation method. The method includes
selecting, by a user, a first target pose and a second target pose from a plurality of preset candidate poses. The first target pose is one of the plurality of candidate poses, the second target pose is another one of the plurality of candidate poses, and the first target pose and the second target pose are two different poses.

At least one intermediate pose is generated by using the first target pose as a starting pose and the second target pose as an ending pose. The at least one intermediate pose is a pose experienced during the transition from the starting pose to the ending pose.

In response to a selection operation on the intermediate pose, display of the specified body part of the model virtual character is switched to a pose modeling corresponding to the intermediate pose. The specified body part may be a hand part or a face part.

In the technical solution provided in this aspect described herein, at least one intermediate pose is generated by using a first target pose as a starting pose and a second target pose as an ending pose, so that the intermediate pose is a candidate pose between the first target pose and the second target pose. The manner of generating the intermediate pose by using the first target pose and the second target pose is beneficial to determining a pose range to which the intermediate pose belongs, thereby improving generation efficiency of the intermediate pose.

In some aspects, the generating at least one intermediate pose by using the first target pose as a starting pose and the second target pose as an ending pose includes:
obtaining first bone position data of the specified body part in the first target pose;
obtaining second bone position data of the specified body part in the second target pose; and
inputting the first bone position data, the second bone position data, and an expected quantity of poses to a neural network model, to obtain an expected pose quantity of intermediate poses.

A training manner of the neural network model is as follows:
obtaining first sample bone position data of the specified body part in a first sample pose, the first sample bone position data including position information of each bone in the specified body part in the first sample pose; and obtaining second sample bone position data of the specified body part in a second sample pose, the second sample bone position data including position information of each bone in the specified body part in the second sample pose.

A sample intermediate pose quantity is obtained, and based on the sample intermediate pose quantity, position data of the same bone in the first sample bone position data and the second sample bone position data is differentiated, to obtain a sample intermediate pose quantity of sample intermediate poses. To be specific, assuming that position information of the same bone in the first sample bone position data is (x1, y1, z1), position information of the same bone in the second sample bone position data is (x2, y2, z2), and the sample intermediate pose quantity is n, position information of an i^{t}h sample intermediate pose is:

i/n*(x1,y1,z1)+(n−i)/n*(x2,y2,z2), i being an integer not greater than n.

The foregoing operations are repeated for each bone in the specified body part, to obtain third sample bone position data in each sample intermediate pose.

The neural network model is trained by using the first sample bone position data, the second sample bone position data, and the sample intermediate pose quantity as input data, and using the third sample bone position data of the sample intermediate pose as label data. To enable the neural network model to be applicable to different intermediate pose quantities, the sample intermediate pose quantity may be set to a plurality of different values, to train a neural network model applicable to different intermediate pose quantities.

In some aspects, the foregoing method further includes: acquiring three-dimensional image data of the specified body part of a user by using a depth camera module; inputting the three-dimensional image data into the neural network model, to obtain bone position data of the specified body part corresponding to the three-dimensional image data; generating a pose modeling of the specified body part of the model virtual character based on the bone position data of the specified body part; and switching display of the specified body part of the model virtual character to the pose modeling.

The neural network model is trained based on the three-dimensional image data and the bone position data of the model virtual character that appear through pairing. The three-dimensional image data of the model virtual character is obtained by acquiring the specified body part of the model virtual character by using a camera model in the virtual environment in a case that different bone positions are set. This training manner does not require training samples of real human body parts, thereby greatly reducing difficulty in constructing a sample training set.

In the technical solution provided in this aspect described herein, a trained neural network model is used to generate an expected quantity of intermediate poses based on first bone position data, second bone position data, and an expected quantity of poses, thereby helping improve precision of generated intermediate poses. In addition, requirements for generating different quantities of intermediate poses can be satisfied, thereby improving flexibility and efficiency of generating the intermediate poses.

### 4. Save of Custom Pose

FIG. 16 is a flowchart of a method for saving a custom pose according to an illustrative aspect described herein. The method includes the following operations.

Operation 391: Display a save button for a custom pose.

There may be more than one display position and timing for the save button.

With reference to FIG. 4, the pose editing interface 20 displays a save button 39. In some aspects, when the pose editing interface is exited, a first pop-up window is displayed, and the save button is displayed within the first pop-up window. In some aspects, when the initial posture of the model virtual character is changed, a second pop-up window is displayed, and the save button is displayed within the second pop-up window.

Operation 392: Store pose data and attached information of the custom pose as a modeling work.

The pose data of the custom pose is absolute pose data or relative pose data relative to the initial pose. The absolute pose data saves position information and rotation information of each bone of the model virtual character in the virtual environment. The relative pose data saves a pose offset value of each bone of the model virtual character relative to the initial pose. In some aspects, the pose offset value includes at least one of a position offset value or a rotation offset value of each bone relative to the initial pose.

The pose data and the attached information of the custom pose are saved as the modeling work of the custom pose. The attached information includes: at least one of a unique identification of the custom pose, account information of a creator, creation time, personalized information of the model virtual character, body shape information of the model virtual character, pose data of the initial pose of the model virtual character, a name of the custom pose, or a preview of the custom pose.

In some aspects, the unique identification of the custom pose is generated by a terminal device or a server.

In conclusion, according to the method provided in this aspect, by saving the pose data and the attached information of the custom pose as the modeling work, the modeling work is saved as a type of UGC, thereby facilitating sharing and applying the custom pose between different accounts.

### 5. Application of Custom Pose

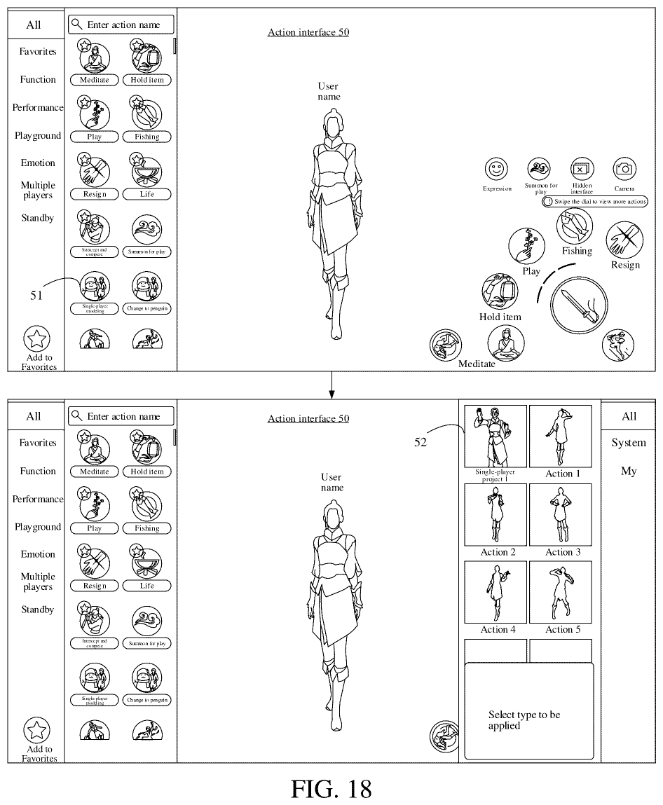

FIG. 17 is a flowchart of a method for applying a custom pose according to an illustrative aspect described herein. The method includes: the following operations.

Operation 393: Display, in response to an operation of applying the custom pose presented by the model virtual character to a first virtual character, the first virtual character in the custom pose.

The first virtual character is a virtual character controlled by a first account. The first account is an account currently logged in on the client.

In some aspects, for example, as shown in FIG. 18, the client displays an action interface 50, and the action interface 50 displays a plurality of action options. The plurality of action options include a single-player modeling option 51. In response to a trigger operation on the single-player modeling option 51, a modeling catalog panel 52 is displayed. The modeling catalog panel 52 displays a plurality of modeling works, and each modeling work corresponds to a preset pose of a system or a custom pose. In some aspects, the modeling catalog panel 52 includes three menu bars: A first menu bar “System” is configured for triggering to display at least one preset pose option of the modeling catalog panel 52, a second menu bar “My” is configured for triggering to display at least one generated pose option of the modeling catalog panel 52, and a third menu bar “All” is configured for triggering to display all pose options owned or collected by a current account in the modeling catalog panel 52.

For example, in response to a selection operation of the user on a modeling work “single-player project 1”, a custom pose corresponding to the modeling work “single-player project 1” is applied to the first virtual character.

In some aspects, the user may alternatively select a modeling work to apply it to the first virtual character through “Camera interface→Actions→Modeling→Right-side list”.

In some aspects, as shown in the top interface diagram in FIG. 7, in the introduction interface 12 of the first modeling work, in response to a trigger operation on an application control for the first modeling work, the first modeling work may alternatively be applied to the first virtual character.

In some aspects, absolute pose data of the custom pose is obtained, the absolute pose data is applied to the first virtual character, and the first virtual character in the custom pose is displayed.

In some aspects, relative pose data of the custom pose is obtained. The relative pose data of the custom pose is an offset value of the custom pose relative to the initial pose. The absolute pose data of the initial pose corresponding to the custom pose is obtained, and the relative pose data of the custom pose and the pose data of the initial pose are superimposed, to obtain the absolute pose data of the custom pose. The absolute pose data is applied to the first virtual character, to display the first virtual character in the custom pose.

Operation 394: Display, in response to an operation of sharing the custom pose presented by the model virtual character to a second account, sharing information of a modeling work corresponding to the custom pose in a network space to which the second account has access permission, so that the second account applies the custom pose to a second virtual character.

The second virtual character is a virtual character controlled by the second account.

In some aspects, the first account and the second account have a friend relationship. In response to an operation of sharing the custom pose to a chat window or a game mailbox corresponding to the second account, in the chat window or the game mailbox to which the second account has access permission, the sharing information of the modeling work corresponding to the custom pose is displayed, so that the second account applies the custom pose to the second virtual character.

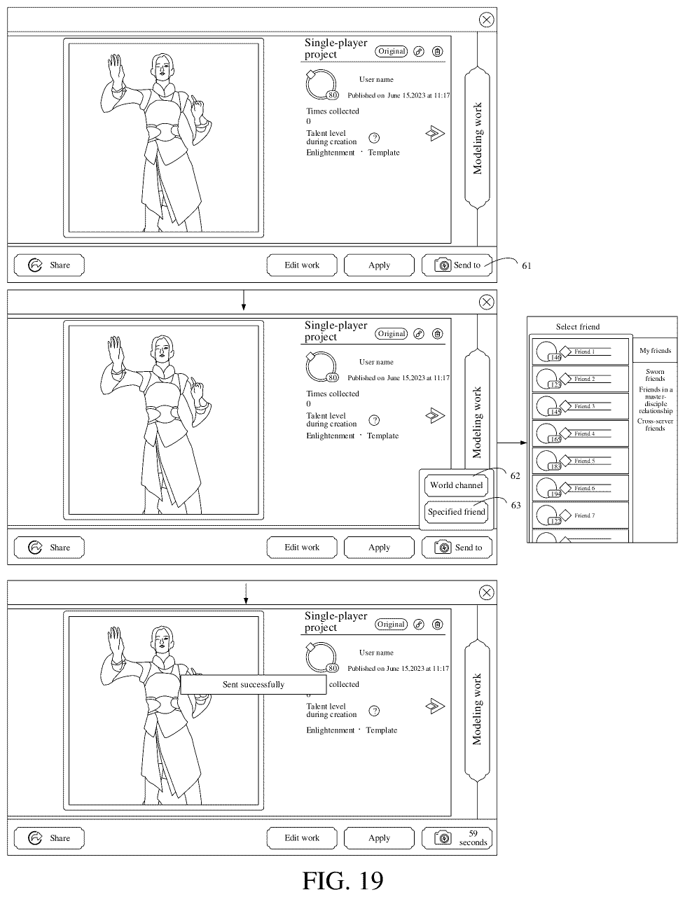

In some aspects, for example, as shown in FIG. 19, the introduction interface for the modeling work displays a “Send to” button 61. In response to a trigger operation on the “Send to” button 61, a world group option 62 and a specified friend option 63 are displayed. In response to a trigger operation on the specified friend option 63, a plurality of friends of the first account on the network are displayed, for example, sworn friends, friends in a master-disciple relationship, and cross-server friends. In response to a trigger operation on the second account, the custom pose is shared to the second account.

In some aspects, the sharing information displays information such as a name, a creator, creation time, and a preview of the modeling work. In response to a trigger operation on the sharing information, related data of the modeling work is saved into a modeling catalog of the second account.

In some aspects, the client on which the second account is logged into obtains the absolute pose data of the custom pose, applies the absolute pose data to the second virtual character, and displays the second virtual character in the custom pose.

In some aspects, the client on which the second account is logged into obtains the relative pose data of the custom pose. The relative pose data of the custom pose is an offset value of the custom pose relative to the initial pose. The absolute pose data of the initial pose corresponding to the custom pose is obtained, and the relative pose data of the custom pose and the pose data of the initial pose are superimposed, to obtain the absolute pose data of the custom pose. The absolute pose data is applied to the second virtual character, to display the second virtual character in the custom pose.

Operation 395: Display, in response to an operation of sharing the custom pose presented by the model virtual character to a specified group, the sharing information of the modeling work corresponding to the custom pose in the specified group, a third account in the specified group applies the custom pose to a third virtual character.

The third virtual character is a virtual character controlled by the third account.

In some aspects, the first account and the third account belong to the same group, but do not necessarily have a friend relationship.

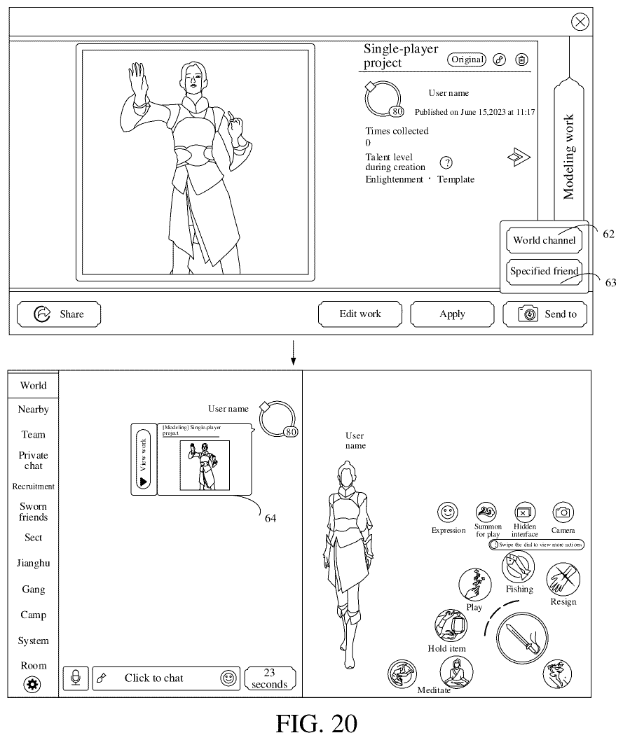

In some aspects, for example, as shown in FIG. 19 and FIG. 20, the introduction interface for the modeling work displays the “Send to” button 61. In response to the trigger operation on the “Send to” button 61, the world group option 62 and the specified friend option 63 are displayed. In response to a trigger operation on the world group option 62, the custom pose is shared to a dialog box of the world group, and displayed as a sharing message 64. Another account in the world group views the preview of the modeling work through the shared message 64, and clicks the sharing message 64 to apply the custom pose to the virtual character controlled by the another account.

In some aspects, the sharing information displays information such as a name, a creator, creation time, and a preview of the modeling work. In response to a trigger operation on the sharing information, related data of the modeling work is saved to a modeling catalog of the third account.

In some aspects, the client on which the third account is logged into obtains the relative pose data of the custom pose. The relative pose data of the custom pose is an offset value of the custom pose relative to the initial pose. The absolute pose data of the initial pose corresponding to the custom pose is obtained, and the relative pose data of the custom pose and the pose data of the initial pose are superimposed, to obtain the absolute pose data of the custom pose. The absolute pose data is applied to the third virtual character, to display the third virtual character in the custom pose.

According to the technical solution provided in this aspect described herein, a custom pose presented by a model virtual character can be applied to a first virtual character controlled by a first account, so that the first virtual character presents the custom pose. This manner can improve application flexibility of the custom pose. A first user may select a preferred custom pose, and apply the custom pose to a virtual character controlled by the first account, thereby achieving pose editing on the virtual character controlled by the first account.

In addition, the first account can share the custom pose to a second account, so that the second account applies the custom pose shared by the first account to a virtual character controlled by the second account, to satisfy a sharing requirement of the user and a pose application requirement of another user, thereby enriching human computer interaction forms.

Further, the first account can share the custom pose with a specified group, and a user in the specified group can apply the custom pose shared by the first account to a virtual character controlled by the user. This manner satisfies the user requirement to share the custom pose with a plurality of users at a time, and all users in the specified group can apply the custom pose, which is beneficial to improving pose editing efficiency.

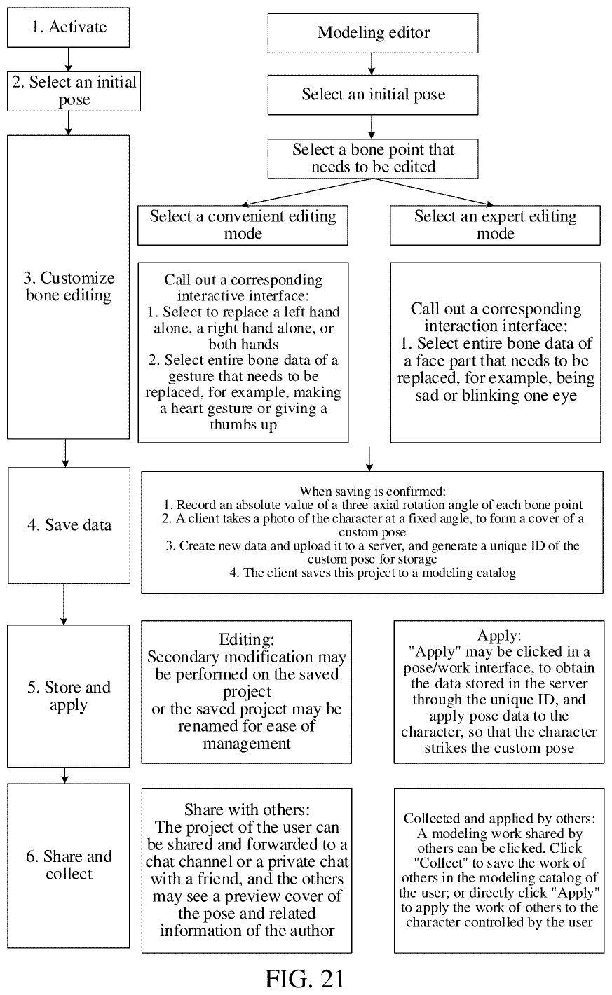

FIG. 21 is a flowchart of a pose editing method for a complex part according to an illustrative aspect described herein. The method is performed by a terminal device, and a client logged into a first account is run in the terminal device. The method includes the following operations.

### 1. Activate.

A user may open a modeling editor through an entry to the modeling editor in the client.

In some aspects, the modeling editor may be opened through New single-player work. After secondary confirmation of the user, the modeling editor is transferred into an independent virtual environment, entering a modeling system. The independent virtual environment may be considered as a bitplane dedicated to modeling.

### 2. Select an Initial Pose.

A plurality of preset poses are provided after the modeling system is entered, and the plurality of preset poses are several different poses automatically configured by the modeling system. In this case, the user may select one of the preset poses as the initial pose.

3. Customize Replacement of a Hand Part (which May be a Left Hand, a Right Hand, or Both Hands) and an Entire Skeleton of a Face Part.

Since the system defaults to a joint mode upon entry, bone points of a character are displayed. A player may select a bone point that needs to be edited to replace a local action bone. For example, a pose editing mode and an expression editing mode may be selected to customize a hand action and a facial expression.

When the pose editing mode is selected, a corresponding interaction interface pops up. The player may select to replace a left hand/a right hand/both hands, and then select whole entire bone data of the gesture that needs to be replaced, for example, making a heart gesture or giving a thumbs up.

When the expression editing mode is selected, a corresponding interactive interface pops up. The player may select entire bone data of the face part that needs to be replaced, for example, the player is sad or blinks one eye.

### 4. Save Data.

The user may save the custom pose. When saving is confirmed, the modeling system records an absolute value of a rotation angle of each bone point. In addition, the client takes a photo of the character at a fixed angle, to form a cover of a new pose. Then, new data is created and uploaded to the server, and a unique ID is generated for storage. The client saves the project to a portfolio UI of the user.

### 5. Store and Apply.

The user may perform secondary modification on the saved modeling work, or name the saved modeling work for ease of management. In addition, the user may click “Apply” in a pose/work interface, to obtain the data stored in the server through the unique ID, and apply the pose data to a virtual character controlled by the user, so that the virtual character controlled by the user is in the custom pose.

### 6. Share and Collect.

The user may forward and share the project to others, and the others person see the preview cover of the modeling work and related information of the author. The user may further click on a modeling work shared by others to collect the modeling work shared by others, and add the modeling work shared by others to a modeling portfolio of the user. Alternatively, the user may directly click on the modeling work for application, to apply the modeling work shared by others to the virtual character controlled by the user.

The foregoing method aspects may be combined in pairs or multiple configurations based on understanding of a person skilled in the art, to form more aspects. Details are not described again in this application.

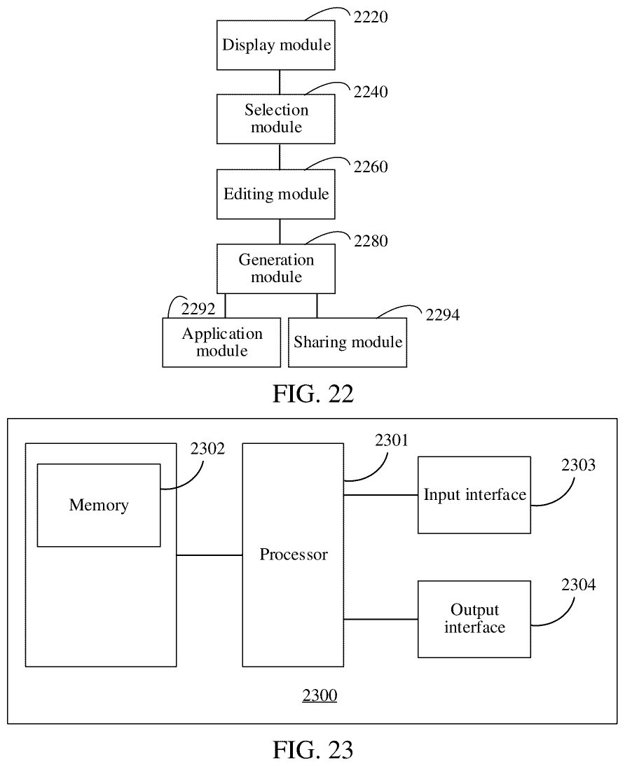

FIG. 22 is a schematic structural diagram of a pose editing apparatus for a complex part according to an illustrative aspect described herein. The apparatus includes:
a display module 2220, configured to display a model virtual character located in a virtual environment;
a selection module 2240, configured to display at least one candidate pose of a specified body part of the model virtual character, the candidate pose being configured for presenting the specified body part in a preset pose modeling; and
an editing module 2260, configured to switch, in response to a selection operation on a target pose of the at least one candidate pose, display of the specified body part of the model virtual character to a pose modeling corresponding to the target pose.

In some aspects, the specified body part includes: a hand part;
the display module 2220 is configured to display at least one candidate hand pose of the hand part of the model virtual character; and the editing module 2260 is configured to switch, in response to a selection operation on a target hand pose of the at least one candidate hand pose, display of the hand part of the model virtual character to a hand modeling corresponding to the target hand pose.

In some aspects, the display module 2220 is configured to display a first selection control and a second selection control; and the editing module 2260 is configured to switch, in response to the selection operation on the target hand pose of the at least one candidate hand pose and the first selection control being in a selected state, display of a hand part of the model virtual character that is located on a left side of the model virtual character to the hand modeling corresponding to the target hand pose; or switch, in response to the selection operation on the target hand pose of the at least one candidate hand pose and the second selection control being in the selected state, display of a hand part of the model virtual character that is located on a right side of the model virtual character to the hand modeling corresponding to the target hand pose.

In some aspects, the display module 2220 is configured to display a third selection control; and

the editing module 2260 is configured to switch, in response to the selection operation on the target hand pose of the at least one candidate hand pose and the third selection control being in the selected state, display of the two hand parts of the model virtual character to the hand modeling corresponding to the target hand pose.

In some aspects, the specified body part includes: a face part;
the display module 2220 is configured to display at least one candidate expression pose of the face part of the model virtual character; and
the editing module 2260 is configured to switch, in response to a selection operation on a target expression pose of the at least one candidate expression pose, display of the face part of the model virtual character to an expression modeling corresponding to the target expression pose.

In some aspects, the target pose includes: a first target pose and a second target pose; and
the editing module 2260 is configured to generate at least one intermediate pose by using the first target pose as a starting pose and using the second target pose as an ending pose; and switch, in response to a selection operation on the intermediate pose, display of the specified body part of the model virtual character to a pose modeling corresponding to the intermediate pose.

In some aspects, the editing module 2260 is configured to obtain first bone position data of the specified body part in the first target pose; obtain second bone position data of the specified body part in the second target pose; and input the first bone position data, the second bone position data, and an expected quantity of poses to a neural network model, to obtain the expected quantity of intermediate poses.

In some aspects, the display module 2220 is further configured to display at least one preset pose option, the preset pose option being a pose option natively provided by an application; and the editing module 2260 is configured to set, in response to a selection operation on a first pose option of the at least one preset pose option, an initial pose of the model virtual character in the virtual environment to a first pose corresponding to the first pose option.

In some aspects, the display module 2220 is further configured to display at least one generated pose option, the generated pose option being a pose option corresponding to a custom pose edited by a user; and the editing module 2260 is configured to set, in response to a selection operation on a second pose option of the at least one generated pose option, the initial pose of the model virtual character in the virtual environment to a second pose corresponding to the second pose option.

In some aspects, the apparatus further includes: a generation module 2280, configured to generate, based on the custom pose presented by the model virtual character, pose data configured for applying the custom pose to a virtual character controlled by at least one account.

In some aspects, a first account is logged into on a client on the apparatus, and the apparatus further includes:
an application module 2292, configured to display, in response to an operation of applying the custom pose presented by the model virtual character to a first virtual character, the first virtual character in the custom pose,
the first virtual character being a virtual character controlled by the first account.

In some aspects, the first account is logged into on a client on the apparatus, and the apparatus further includes:
a sharing module 2294, configured to display, in response to an operation of sharing the custom pose presented by the model virtual character to a second account, sharing information of the custom pose in a network space to which the second account has access permission, so that the second account applies the custom pose to a second virtual character,
the second virtual character being a virtual character controlled by the second account.

In some aspects, the first account is logged into on a client on the apparatus, and the apparatus further includes:
a sharing module 2294, configured to display, in response to an operation of sharing the custom pose presented by the model virtual character to a specified group, the sharing information of the custom pose in the specified group, so that a third account in the specified group applies the custom pose to a third virtual character,
the third virtual character being a virtual character controlled by the third account.

In a process of pose editing on a complex part by the apparatus provided in the foregoing aspect, only division of the foregoing function modules is used as an example for description. In practical application, the foregoing functions may be allocated to and completed by different function modules according to requirements. That is, an internal structure of a device is divided into different function modules to complete all or some of the functions described above. In addition, for details of a specific implementation process, refer to the method aspects, and details are not described herein again.

FIG. 23 is a structural block diagram of a computer device 2300 according to an illustrative aspect described herein.

Generally, the computer device 2300 includes: a processor 2301 and a memory 2302.

The processor 2301 may include one or more processing cores, for example, a 4-core processor or an 8-core processor. The processor 2301 may be implemented by using at least one hardware form of a digital signal processing (DSP), a field-programmable gate array (FPGA), or a programmable logic array (PLA). The processor 2301 may also include a main processor and a co-processor. The main processor is a processor configured to process data in a wakeup state, and is also referred to as a central processing unit (CPU); and the co-processor is a low-power processor configured to process data in a standby state. In some aspects, the processor 2301 may be integrated with a graphics processing unit (GPU), and the GPU is configured to be responsible for rendering and drawing content that needs to be displayed on a display screen. In some aspects, the processor 2301 may further include an artificial intelligence (AI) processor, and the AI processor is configured to process a calculation operation related to machine learning.

The memory 2302 may include one or more computer-readable storage media. The computer-readable storage medium may be non-transitory. The memory 2302 may further include a high-speed random access memory, and a non-volatile memory such as one or more magnetic disk storage devices and flash storage devices. In some aspects, a non-transitory computer-readable storage medium in the memory 2302 is configured to store at least one instruction, the at least one instruction being configured to be executed by the processor 2301 to implement the pose editing method for a complex part provided in the method aspects described herein.

In some aspects, the computer device 2300 may further include: an input interface 2303 and an output interface 2304. The processor 2301, the memory 2302, the input interface 2303, and the output interface 2304 may be connected to each other by using a bus or a signal cable. Each peripheral device may be connected to the input interface 2303 and the output interface 2304 through a bus, a signal cable, or a circuit board. The input interface 2303 and the output interface 2304 may be configured to connect at least one peripheral device related to input/output (I/O) to the processor 2301 and the memory 2302. In some aspects, the processor 2301, the memory 2302, the input interface 2303, and the output interface 2304 are integrated on the same chip or circuit board. In some other aspects, any one or two of the processor 2301, the memory 2302, the input interface 2303, and the output interface 2304 may be implemented on an independent chip or circuit board. This is not limited in the aspects described herein. A person skilled in the art may understand that the foregoing shown structure does not constitute a limitation to the computer device 2300, and the computer device 2300 may include more components or fewer components than those shown in the figure, or some components may be combined, or a different component deployment may be used.

In an illustrative aspect, a computer device is further provided. The computer device includes: a processor and a memory, the memory having a computer program stored therein, the computer program being loaded and executed by the processor, to implement the pose editing method for a complex part described above.

In an illustrative aspect, a chip is further provided, the chip including a programmable logic circuit and/or program instructions, and a server or a terminal installed with the chip being configured to implement the pose editing method for a complex part described above.

In an illustrative aspect, a computer-readable storage medium is further provided. The storage medium has at least one program stored therein, and the at least one program, when executed by a processor, is configured to implement the pose editing method for a complex part described above. In an illustrative aspect, the computer-readable storage medium may be a read-only memory (ROM), a random access memory (RAM), a compact disc read-only memory (CD-ROM), a magnetic tape, a floppy disk, an optical data storage device, or the like.

In an illustrative aspect, a computer program product is further provided. The computer program product includes a computer program, the computer program is stored in a computer-readable storage medium, a processor reads the computer program from the computer-readable storage medium, and the processor executes the computer program, to implement the pose editing method for a complex part described above.

What is claimed is:

1. A computer-implemented method comprising:
displaying a model virtual character located in a virtual environment, said virtual character comprising a plurality of posable body parts;
displaying at least one candidate pose of a specified body part of the plurality of posable body parts of the model virtual character, the candidate pose being configured for presenting the specified body part in a preset pose; and
switching, in response to a selection of a target pose of the at least one candidate pose, display of the specified body part of the model virtual character to a pose corresponding to the target pose.

2. The method according to claim 1, wherein the specified body part comprises a hand,
wherein the displaying at least one candidate pose comprises displaying at least one candidate hand pose; and
wherein the switching comprises switching, in response to a selection operation on a target hand pose of the at least one candidate hand pose, display of the hand part of the model virtual character to a hand pose corresponding to the target hand pose.

3. The method according to claim 2, wherein the method further comprises:
displaying a first selection control; and
the switching, in response to the selection operation on the target hand pose, comprises:
switching, in response to the selection operation on the target hand pose of the at least one candidate hand pose and the first selection control being in a first state, display of a hand part of the model virtual character that is located on a left side of the model virtual character to the hand pose corresponding to the target hand pose;
or
switching, in response to the selection operation on the target hand pose of the at least one candidate hand pose and the first selection control being in a second state, display of a hand part of the model virtual character that is located on a right side of the model virtual character to the hand pose corresponding to the target hand pose.

4. The method according to claim 2, further comprising:
displaying a first selection control; and
the switching, in response to the selection operation on the target hand pose, comprises:
switching, in response to the selection operation on the target hand pose of the at least one candidate hand pose and the first selection control being in the selected state, display of two hand parts of the model virtual character to the hand pose corresponding to the target hand pose.

5. The method of claim 1, wherein the specified body part comprises a face;
wherein the displaying at least one candidate pose of the specified body part of the model virtual character comprises:
displaying at least one candidate expression pose of the face of the model virtual character; and
the switching, in response to the selection operation on the target pose, comprises:
switching, in response to a selection operation on a target expression pose of the at least one candidate expression pose, display of the face part of the model virtual character to an expression corresponding to the target expression pose.

6. The method of claim 1, wherein the target pose comprises: a first target pose and a second target pose; and
the method further comprises:
generating at least one intermediate pose by using the first target pose as a starting pose and the second target pose as an ending pose; and
switching, in response to a selection operation on the intermediate pose, display of the specified body part of the model virtual character to a pose corresponding to the intermediate pose.

7. The method according to claim 6, wherein the generating at least one intermediate pose comprises:
obtaining first bone position data of the specified body part in the first target pose;
obtaining second bone position data of the specified body part in the second target pose; and
inputting the first bone position data, the second bone position data, and an expected quantity of poses into a neural network model, to obtain the quantity of intermediate poses.

8. The method of claim 1, further comprising:
displaying at least one preset pose option, the preset pose option being a pose option natively provided by an application; and
setting, in response to a selection of a first pose option of the at least one preset pose option, an initial pose of the model virtual character in the virtual environment to a first pose corresponding to the first pose option.

9. The method of claim 1, further comprising:
displaying at least one generated pose option, the generated pose option being a pose option corresponding to a custom pose edited by a user; and
setting, in response to a selection of a first pose option of the at least one generated pose option, the initial pose of the model virtual character in the virtual environment to a first pose corresponding to the second pose option.

10. The method of claim 9, further comprising:
generating, based on the custom pose presented by the model virtual character, pose data configured for applying the custom pose to a virtual character controlled by at least one account.

11. The method of claim 9, wherein the method is performed by a client that logs into a first account on the computer device, and the method further comprises:
displaying, in response to an operation of applying the custom pose presented by the model virtual character to a first virtual character, the first virtual character in the custom pose,
the first virtual character being a virtual character controlled by the first account.

12. The method of claim 9, wherein the method is performed by a client that logs into the first account on the computer device, and the method further comprises:
displaying, in response to an operation of sharing the custom pose presented by the model virtual character to a second account, sharing information corresponding to the custom pose in a network space to which the second account has access permission, so that the second account is enabled to apply the custom pose to a second virtual character,
the second virtual character being a virtual character controlled by the second account.

13. The method of claim 9, wherein the method is performed by a client that logs into the first account on the computer device, and the method further comprises:
displaying, in response to an operation of sharing the custom pose presented by the model virtual character to a specified group, sharing information corresponding to the custom pose in the specified group, so that a third account in the specified group is enabled to apply the custom pose to a third virtual character,
the third virtual character being a virtual character controlled by the third account.

14. One or more non-transitory computer readable media comprising computer readable instructions which, when executed by a processor, configure a data processing system to perform:
displaying a model virtual character located in a virtual environment, said virtual character comprising a plurality of posable body parts;
displaying at least one candidate pose of a specified body part of the plurality of posable body parts of the model virtual character, the candidate pose being configured for presenting the specified body part in a preset pose; and
switching, in response to a selection of a target pose of the at least one candidate pose, display of the specified body part of the model virtual character to a pose corresponding to the target pose.

15. The computer readable media according to claim 14, wherein the specified body part comprises a hand,
wherein the displaying at least one candidate pose comprises displaying at least one candidate hand pose; and
wherein the switching comprises switching, in response to a selection operation on a target hand pose of the at least one candidate hand pose, display of the hand part of the model virtual character to a hand pose corresponding to the target hand pose.

16. The computer readable media according to claim 15, wherein the computer readable instructions, when executed, further configure the data processing system to perform:
displaying a first selection control; and
the switching, in response to the selection operation on the target hand pose, comprises:
switching, in response to the selection operation on the target hand pose of the at least one candidate hand pose and the first selection control being in a first state, display of a hand part of the model virtual character that is located on a left side of the model virtual character to the hand pose corresponding to the target hand pose;
or
switching, in response to the selection operation on the target hand pose of the at least one candidate hand pose and the first selection control being in a second state, display of a hand part of the model virtual character that is located on a right side of the model virtual character to the hand pose corresponding to the target hand pose.

17. The computer readable media according to claim 15, wherein the computer readable instructions, when executed, further configure the data processing system to perform:
displaying a first selection control; and
the switching, in response to the selection operation on the target hand pose, comprises:
switching, in response to the selection operation on the target hand pose of the at least one candidate hand pose and the first selection control being in the selected state, display of two hand parts of the model virtual character to the hand pose corresponding to the target hand pose.

18. The computer readable media of claim 14, wherein the specified body part comprises a face;
wherein the displaying at least one candidate pose of the specified body part of the model virtual character comprises:
displaying at least one candidate expression pose of the face of the model virtual character; and
the switching, in response to the selection operation on the target pose, comprises:
switching, in response to a selection operation on a target expression pose of the at least one candidate expression pose, display of the face part of the model virtual character to an expression corresponding to the target expression pose.

19. The computer readable media of claim 14, wherein the target pose comprises: a first target pose and a second target pose; and
the method further comprises:
generating at least one intermediate pose by using the first target pose as a starting pose and the second target pose as an ending pose; and
switching, in response to a selection operation on the intermediate pose, display of the specified body part of the model virtual character to a pose corresponding to the intermediate pose.

20. A system, comprising:
a processor; and
memory storing computer readable instructions which, when executed by the processor, configure the system to perform:
displaying a model virtual character located in a virtual environment, said virtual character comprising a plurality of posable body parts;
displaying at least one candidate pose of a specified body part of the plurality of posable body parts of the model virtual character, the candidate pose being configured for presenting the specified body part in a preset pose; and
switching, in response to a selection of a target pose of the at least one candidate pose, display of the specified body part of the model virtual character to a pose corresponding to the target pose.
